(19) United States
(12) Patent Application Publication
(10) Pub. No.: US 2007/0255608 A1
(43) Pub. Date: Nov. 1, 2007

(54) Dynamic product control using information technology-supported systems

(76) Inventor: Harald Igler, Hausen (DE)

Correspondence Address: BRINKS HOFER GILSON & LIONE, P.O. BOX 10395, CHICAGO, IL, 60610, US

(21) Appl. No.: 11/415,440

(22) Filed: May 1, 2006

(51) Int. Cl. G05B 19/418

(52) U.S. Cl. 705/8

(57) ABSTRACT

A system, method, and program route system components, such as repair parts for products in the field, to various locations. A component may be routed via a first route to a first location associated with a first customer from a central warehouse. A determination may be made after a servicing action at the first location as to whether the component remains in working condition. Subsequently, a second route may be automatically determined that will route the component directly to a second location from the first location based upon whether the component remains in working condition. If the component remains in working condition, the component may be routed from the first location directly to a second location associated with a second customer. On the other hand, if the component no longer remains in working condition, the component may be routed from the first location directly to a repair facility.

### BACKGROUND

The present embodiments relate generally to the routing of items between locations. In particular, the present embodiments relate to the dynamic routing of system components.

To maintain the quality of products/machines having a number of components located at various customer locations, the products have to be periodically repaired and/or serviced using spare parts. Conventional methods that supply customers with spare parts require a high degree of logistical support, including warehouse capacity, such as a central warehouse at which a large inventory of spare parts is normally maintained.

Typically, defects with a product in the field cannot be quickly diagnosed or unambiguously technically categorized based solely upon the symptoms currently exhibited by the product. As a result, to facilitate troubleshooting, multiple replacement parts are often shipped to the customer location after a problem with the product arises. However, this may result in an excessive number of parts in circulation throughout the field, which entails associated costs. After the maintenance action is completed, the excess parts not used to repair the product are shipped back to the central warehouse, which also entails costs.

The identification of defective repair parts is problematic. For instance, parts that are shipped to a first customer may have been initially defective. Parts also may be damaged during shipment to the customer or while troubleshooting the product in the field. However, with conventional methods, defective repair parts may not be timely identified and/or tracked, resulting in some defective parts being needlessly shipped to a second customer after they have been returned to the central warehouse. Furthermore, with conventional methods, considerable amounts of manual labor may be expended at the central warehouse attempting to identify all of the defective parts.

### BRIEF SUMMARY

By way of introduction, the embodiments described below include methods, processes, apparatuses, instructions, or systems for routing system components, such as repair parts for products in the field. Initially, a component may be routed to a first customer for a servicing action. After a servicing action at the first customer's location, a determination may be made as to whether the component remains in working condition or is otherwise re-usable. Subsequently, the component may be routed from the first customer's location directly to a second customer if the component remains in working condition. On the other hand, if the component no longer remains in working condition, the component may be routed from the first customer's location directly to a repair facility. The routes by which the component is shipped may be automatically determined. The routes may be the most efficient and/or economical routes available based upon shipping information.

In a first aspect, a method routes system components. The method may include routing a component via a first route to a first location from a central warehouse and determining with an Information Technology system whether the component remains in working condition after a servicing action at the first location. The method also may include determining a second route that will route the component directly to a second location from the first location based upon whether the component remains in working condition at the first location after the servicing action and routing the component via the second route to the second location.

In a second aspect, a method routes system components. The method may include remotely maintaining the status of a component located at a first location, the status of the component includes whether the component remains in working condition and the first location is associated with a first customer. The method also may include remotely routing via an Information Technology system the component directly to a second location, the determination of the second location is based upon whether or not the component remains in working condition at the first location.

In a third aspect, a processing system is operable to route components. The system may include a processor operable to remotely maintain the current status of a component located at a first location associated with a first customer. The processor may be operable to determine a route by which the component may be transported from the first location directly to a second location based upon the current status of the component at the first location.

In a fourth aspect, a computer-readable medium having instructions executable on a computer stored thereon is described. The instructions may include receiving information detailing the current status of a component, the component being located at a first remote location and determining an optimum route from the first remote location to a second remote location based upon the current status of the component at the first remote location.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The present embodiments will become more fully understood from the detailed description given herein below and the accompanying drawings which are given by way of illustration only, and are not limitative of the present invention, and wherein:

FIG. 1 depicts a conventional routing process;

FIG. 2 illustrates an exemplary method for routing system components to various locations;

FIG. 3 depicts an exemplary workflow of routing system components to a repair facility;

FIG. 4 depicts another exemplary workflow of routing system components to various locations; and

FIG. 5 is an exemplary data processing system.

### DETAILED DESCRIPTION OF THE DRAWINGS AND PRESENTLY PREFERRED EMBODIMENTS

A system, method, and software code provide a workflow for routing system components, such as repair parts for products in the field, to various locations. A component may be initially routed from a central warehouse to a first customer for a servicing action via a first route. A status of the component may be determined at the first customer location, such as after arrival or after the servicing action has been performed. The status of the component may include information detailing whether the component remains in working condition or is otherwise re-usable after use at the customer's location. The status also may facilitate identifying whether or not the component arrived at the customer's location in working condition, or not in working condition, such as the so-called “Dead On Arrival” or DOA situation.

Subsequently, a second route may be automatically determined that will route the component from the first location directly to a second location based upon whether the component remains in working condition and/or other status information. If the component remains in working condition, the component may be routed from the first customer location directly to a second location associated with a second customer. On the other hand, if the component no longer remains in working condition, the component may be routed from the first customer location directly to a second location associated with a repair facility. In other words, the component may be routed from the first customer location to either a second customer location or a repair facility directly, eliminating routing the component back to the central warehouse or other intermediate storage facility.

The first and second routes may each be automatically determined to be the optimum route from “point A to point B” based upon shipping information. For instance, the routes may be calculated to be either the most cost effective or time efficient manner of shipping the component from point A to point B, or the routes may be determined taking into consideration both cost and time factors.

The workflow may include tracking the location of the component as it is routed from location to location, as well as monitoring the status of the component out in the field, from a remote location. As a result, the workflow may enhance the control of system components, such as spare or replacement parts, so that fewer total parts are shipped to customers. Additionally, the workflow may efficiently identify any defective components and subsequently reduce the number of defective parts that are shipped to customers.

In one embodiment, the workflow includes remotely monitoring the status of system components in the field. A system component may be shipped to a customer location for diagnostic testing a larger product. At the customer location, the system component may arrive damaged, be damaged during troubleshooting, not used during the troubleshooting, or used during the troubleshooting. If the component was used during the troubleshooting, it may or may not be re-usable. For example, the component may need to be repackaged, calibrated, tested, or otherwise checked by a technician. All of the above information may be used to define the current status of the component as discussed herein. By remotely monitoring the status of the component, the component may be directly routed to a proper next destination, such as a next customer location, a repair facility, a central warehouse, or other destination.

### I. Conventional Routing Process

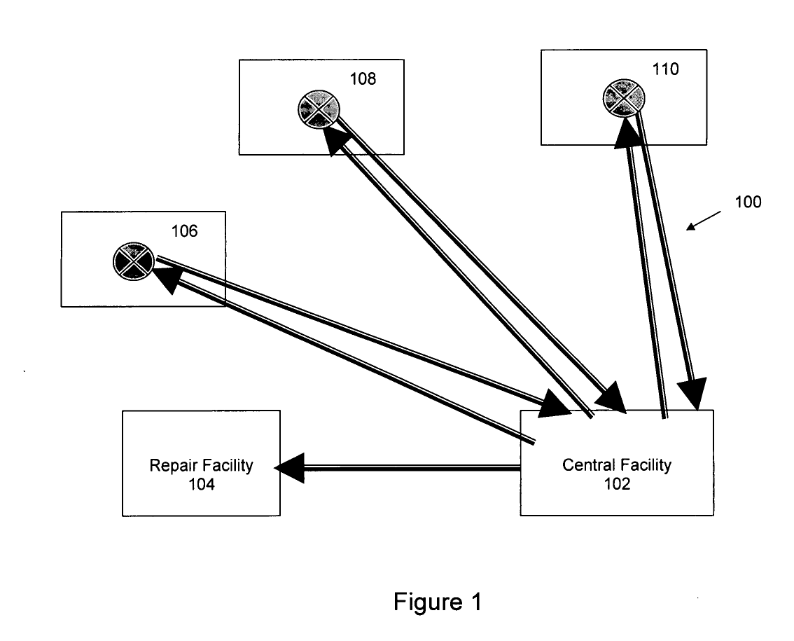

FIG. 1 illustrates a conventional routing process 100. The conventional process may include a central facility or warehouse 102, a repair facility 104, and customer locations 106, 108, 110. Each of the customer locations 106, 108, 110 may have one or more products/machines that consist of numerous smaller components. However, with time, the products in the field may require repair or other servicing action, such as when one or more of the smaller system components break or wear out. With some component failures, it may be difficult to quickly categorize what the problem is based upon the symptoms exhibited by the product. In other words, sometimes it is not possible to narrowly identify the problem and the exact system components that need replacement.

Accordingly, the conventional processes may require that for a generally categorized problem, numerous replacement parts be sent to a customer location for diagnostic testing. Diagnostic testing is intended to isolate and then eliminate the problem, such as by replacing any damaged system components with replacement components. With only being to generally identify the problem in numerous cases, extraneous spare components may be shipped to the customer in an effort to ensure that the correct component is shipped and return the product in the field to working order as quickly as possible. However, this results in an excessive number of system components in circulation in the field, which entails certain unnecessary expenditures. Furthermore, after a typical servicing action, a number of system components are shipped back to the central warehouse 102.

With conventional processes, any information related to the components, such as whether each component may still be used or has to be repaired, needs to be acquired on-site at the central warehouse 102. As such, the defective components may only be identified, if at all, when they are physically returned to the central warehouse 102. Furthermore, during diagnostic testing at a customer location 106, 108, 110 one or more replacement components may be broken or otherwise damaged. A damaged component may not be identified with conventional processes until the damaged component is shipped to the next customer from the central warehouse 102 for diagnostic testing on a second machine, which is one example of a DOA situation.

As shown in FIG. 1, with conventional processes, the system components are shipped from a central facility 102 to a customer location 106, 108, and 110. After a servicing action, the components are shipped back to the central warehouse 102 from the customer location 106, 108, and 110. Some components that are manually identified as being defective may then be shipped from the central warehouse 102 to a repair facility 104. After repair, the components may be shipped from the repair facility 104 back to the central warehouse 102. Accordingly, conventional processes may that require components be routed through a central location.

### II. Exemplary Workflows

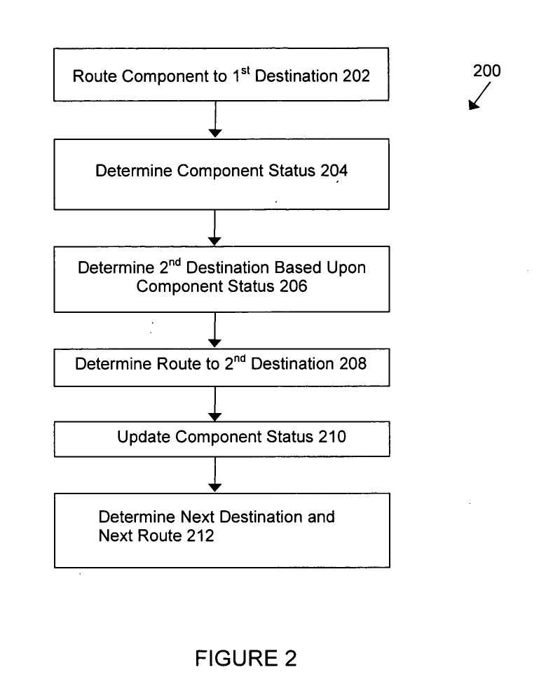

FIG. 2 illustrates an exemplary method for routing system components to various locations. The method may include routing a component to a first location 202, determining the status of the component at the first location 204, determining a second location to route the component to based upon the status of the component 206, determining a route to the second location 208, updating the status of the component at the second location 210, and determining a next location to route the component to and the next route 212. The method may include additional, fewer, or alternative actions.

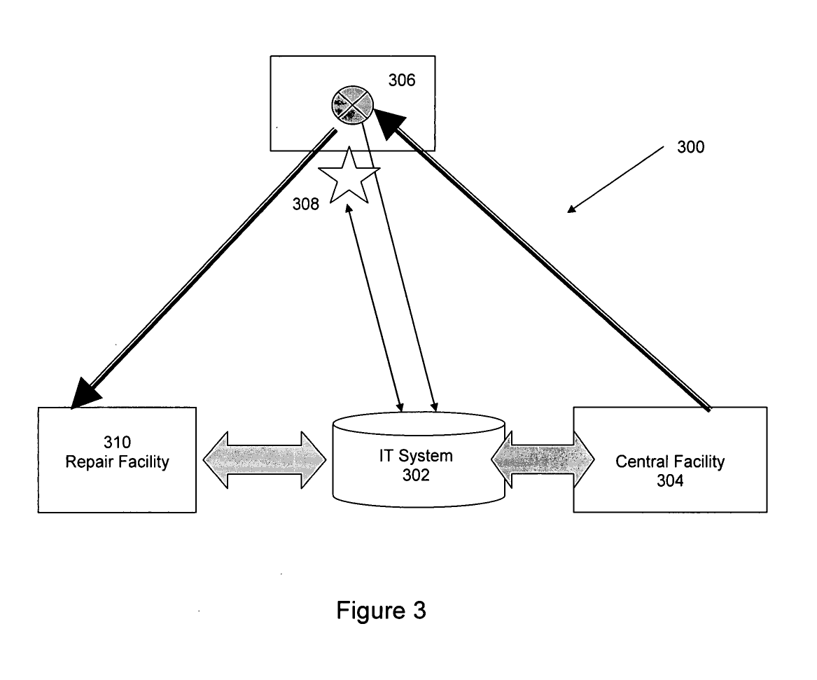

The method may include routing the component to a first location 202. FIG. 3 depicts an exemplary workflow of routing system components to various locations. The workflow may involve an Information Technology (“IT”) system 302, a central facility 304, a customer location 306, a drop point 308, and a repair facility 310. In one embodiment, the central facility 304 may be a central facility within a warehouse. The workflow may entail additional, fewer, or alternative components and locations.

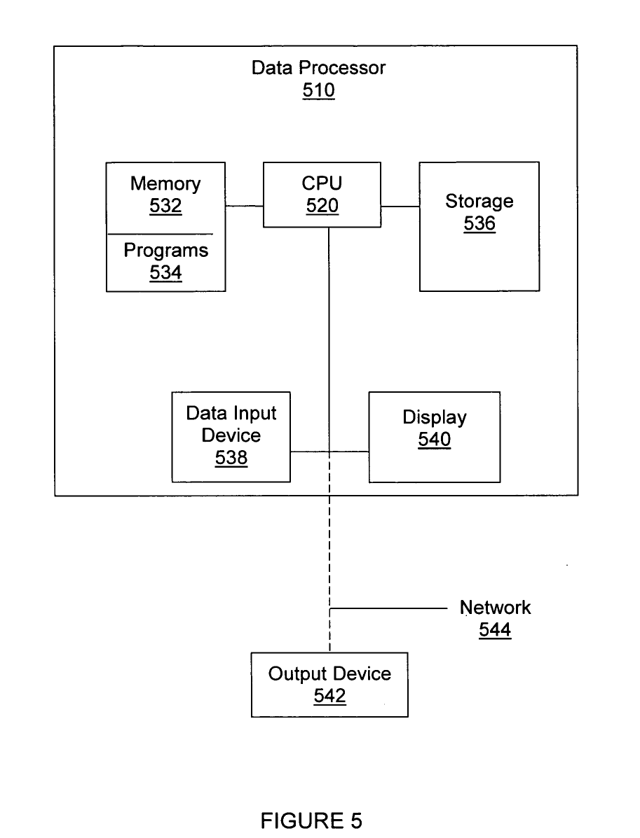

IT or Information Technology as used herein refers to the branch of engineering that deals with the use of computers and telecommunications to retrieve, store, and transmit information. The IT system 302 may include the data processing system as described below with respect to FIG. 5. Other IT systems having more, less, or alternative functionality may be used.

Initially, the IT system 302 may receive a request for specific system components from a customer location 306 or a drop point 308 associated with the customer location 306, such as an airport, train station, railroad station, bus station, trucking facility, post office, or other location in the vicinity of the customer location. The request may be for one or more specific system components that need replacement or system components that are associated with either routine periodic maintenance or the diagnostic testing of a larger product located at the customer location 306, or other component requests.

After which, the IT system 302 may determine the location of the system component(s) requested. The system components may be currently located at a central facility 304, a repair facility 310, other customer location, or other location. The IT system 302 will then determine a shipping route from where the system components are currently located to the destination, which may be either the customer location 306 itself or an associated drop point 308.

The shipping route determined by the IT system for each component may be the optimum route based upon currently available shipping information. The IT system may include a map of all locations associated with a geographical area, such as all central warehouses, customer locations, drop points, repair facilities, and other locations. The IT system may store data which includes all logistical and shipping information for each geographical area.

As a result, the IT system may determine either the most cost effective or time efficient manner of routing each component to the destination, or a route that takes into consideration both time and cost factors. The IT system may determine the fastest and/or least expensive manner of shipment based upon airplane, train, bus, ship, truck, post office, and/or shipping company schedules and fares. In one embodiment, such information may be periodically downloaded or downloaded “on demand” from a network, such as the Internet, an intranet, or other communications network.

The example of FIG. 3 shows that the IT system has determined that a requested system component is initially located at a central facility 304. The IT system, upon receiving a request from the customer or a field technician (who may intend to use the system component at the customer location) that the system component be shipped directly to the customer location 306, determines a shipping route from the central facility 304 to the customer location 306. After which, the system component is shipped from the central facility 304 to the customer location via the route determined.

Alternatively, the customer or field technician may request that the system component be initially routed to a drop point 308. The drop point 308 may be an intermediate shipping point along the route to the customer location 306 or other location in the general vicinity of the customer location 306. In such a case, the IT system will determine an appropriate route and then route the system component to the drop point 308 or other nearby location. Alternate destinations and routes may be used to ship the component to the first location.

The method may include determining a component status at the first location 204. As shown in FIG. 3, the first location/destination of the system component may be the customer location 306 or an associated drop point 308. Once the system component has arrived at the first location, an initial check of the component may be performed, such as by a field technician. Alternatively, a check of the component may be performed after the component has been used during a servicing action, diagnostic testing, troubleshooting, or other maintenance activity. During the check of the component, the field technician may manually or automatically (using a device) determine the current status of the component at the first location. The component status may include whether or not the component remains in working order or is otherwise re-usable, as well as the current location or drop point of the component. For instance, the component may need to be repaired, recalibrated, repackaged, retested, resterilized (such as with an unused but unpackaged medical device), or require other work.

In one embodiment, the status of the component includes the current drop point. The drop point at which the component is currently located may be determined by the IT system, a portion of the IT system located at the drop point, mobile service tools, or other devices that are operable to send a signal to the IT system that facilitates identifying the current drop point. The IT system may include a table or other programming structure that represents all of the drop points. For instance, each drop point may be associated with a number or other drop point identifier. The IT system may contain a map of all the existing drop points, such that when the IT system receives a drop point identifier, the IT system can subsequently determine where on the geographical map the component is currently located. The geographical map that includes the drop points may be presented on a display, along with the component's current location.

In another embodiment, each component may be shipped with an associated identification tag, a small microprocessor, and/or other circuitry. The circuitry may facilitate remotely maintaining the current status up-to-date and remotely tracking the current location of each component. For example, the circuitry may include a small receiver/transceiver for remotely receiving and transmitting information back to the IT system or a network. The circuitry may include a GPS unit or other device which may determine the current location of the component.

In yet another embodiment, the identification tag is a RFID (radio frequency identification) tag. The RFID tag may or may not be associated with a microprocessor. An RFID tag without a microprocessor may provide cost savings. Other means of identification may be used. For instance, an identification code may be stored within a memory unit associated with circuitry or a microprocessor. Alternatively, a passive system may be used that is less complex than a system that involves a microprocessor, such as a barcode label system.

As discussed above, a GPS unit is not necessary when the IT system itself being able to receive, send, or otherwise communicate geographical information associated with the drop points such that the IT system can track and maintain the current location of a component. Alternatively, an IT system that is operable to determine the current drop point of a component may be used in tandem with a GPS unit associated with a component to provide more reliability, as well as a pinpoint location, such as a street address.

In one embodiment, the IT system may receive a request for a particular component that is required at a specific customer location, such as 100 Main St., Customer Town, Ill. The IT system may then identify the nearest drop point at which the particular component is located, such as a drop point associated with Chicago. The IT system may then route the component from the Chicago drop point directly to the customer location located at Customer Town. The use of a GPS unit or other device may facilitate tracking the component in route from the Chicago drop point to the customer location.

The IT system may be operable to perform a pre-calculation without taking into consideration specific or actual components. The pre-calculation may entail a calculation of either the time or the money, or both, required to route a hypothetical component from one location to the next based upon current or known shipping information. The pre-calculation may take into consideration the locations of customers, drop points, repair facilities, warehouses, and other locations. The locations may be stored in a database accessible by the IT system.

The shipping information utilized by the pre-calculation may include standard logistical information associated with a geographical area. For instance, the shipping information may include the name of the shipping company, such as UPS, DHL, etc., the cost of shipping a package between locations, the timeframe associated with each shipping route between locations, and other information. The pre-calculation may take into consideration the size, weight, and other characteristics of each component.

The pre-calculation may entail determining the most cost efficient and/or quickest route of shipping components. The pre-calculation permits the IT system to be able to simulate and calculate the different transport routes. The simulation of available routes, along with associated cost and time data for each route, may be stored in a central database or local database. The IT system may be able to frequently update the database either periodically or in real time. The database may be accessible from each customer location, drop point, central facility, repair facility, or other remote location.

The IT system may use the pre-calculation to facilitate a pre-configuration, such as before a service call is actually necessary. The pre-calculation capability may permit the IT system to generate a report detailing the expected cost savings associated with the embodiments discussed herein. Forecasting projected savings may be desirable for customers.

Field technicians may use various devices to update and maintain the status of components in the field, such as existing mobile service tools, RFID reader units, radio units, PDAs, hand held devices, or other service tools. The service tools may be linked to the IT system or other network in communication with the IT system. In one embodiment, the field technicians may use Scout and/or M-Butler mobile service solutions. Alternate manners of determining and/or relaying the status of the component located at a remote location may be used.

For instance, in one embodiment, the component status may be stored in circuitry associated with each component. The circuitry may be located on shipping packaging or the component itself and may include a memory unit. The status of each component stored locally may then be transmitted from the circuitry to the IT system directly, or to a local network that subsequently relays the status on to the IT system. In another embodiment, the status of each component may be remotely stored in the IT system. The field technician may use the service tool to transmit the current status directly to the IT system, or to a network that relays the status on to the IT system, for subsequent storage in the IT system. After which, a service tool may be used to remotely retrieve the current status of the component stored in the IT system.

The method may include determining a second location/destination based upon the status of the component 206 located at the first destination. If the component is not in working condition when it initially arrives at the customer location 306 or the drop point 308, it is a so-called DOA case. Accordingly, the component may be shipped directly to a repair facility 310. If the component is no longer in working condition after a servicing action, diagnostic testing, troubleshooting, or other maintenance, the component may be shipped directly to a repair facility 310. In both of the above situations, the repair facility 310 chosen may be the repair facility 310 nearest the customer location 306. FIG. 3 shows that the component may be routed directly from the customer location 306 to the repair facility 310.

Alternatively, the status of the component may reveal that the component remains in working condition or is otherwise re-usable. In such a situation, the component may be routed directly from the first location to a second customer location or an associated drop point.

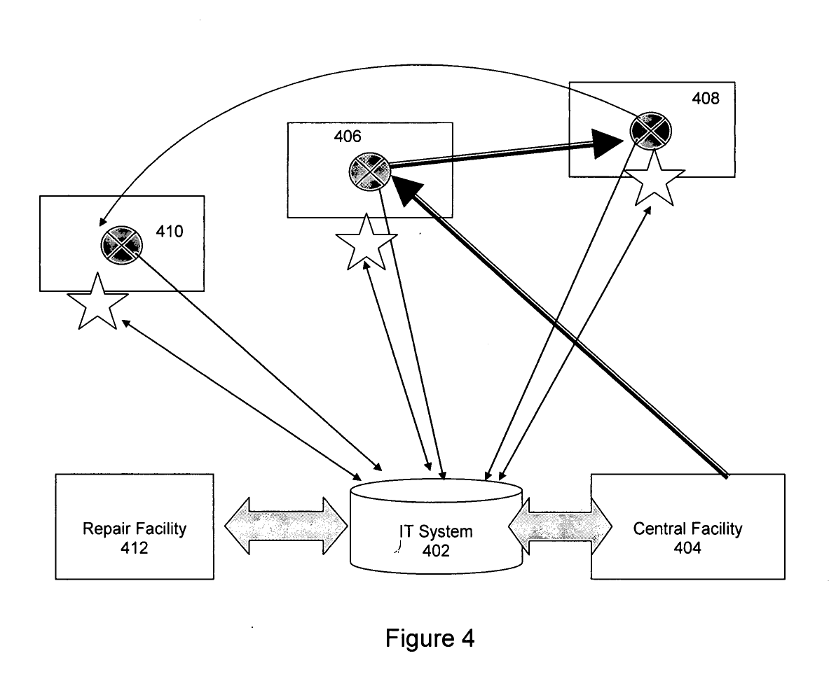

FIG. 4 depicts another exemplary workflow of routing system components to various locations. The workflow may entail an IT system 402, a central facility 404, a first customer location 406, a second customer location 408, a third customer location 410, and a repair facility 412. For example, the first customer location 406 may be Chicago, the second customer location 408 may be New York, and the third customer location 410 may be Los Angeles. Each of the customer locations 406, 408, 410 may have an associated drop point, as indicated by the corresponding star figures. The workflow may include additional, fewer, or alternative locations and components.

In the example of FIG. 4, the component is routed from the central facility 404 to the first customer location 406 after a request for the component is received by the IT system 402. After a servicing action or other maintenance has been performed, the component is determined to be re-usable. Accordingly, the status of the component while located at the first customer location 406 indicates that the component remains in working condition.

A request for the same component is subsequently initiated from the second location 408 or corresponding drop point. The IT system, using the component status, determines that the component currently located at the first customer location 406 may be shipped directly to the second customer location 408, avoiding the need to ship the component to back to the central facility 404 or to another intermediate storage facility. Other routing scenarios may be used.

Once the second destination has been determined based upon the component status 206, the method may include determining a route to the second destination 208. As discussed above, the IT system may again determine an optimum route to the second destination taking cost and time factors into consideration. Alternate factors may be used.

The method may include updating the status of the component at the second destination 210. As before, the status of the component may be updated via a number of manners. With the example shown in FIG. 4, the status may be updated when the component arrives at the second customer location 408 or corresponding drop point. The status may be updated after a servicing action or other maintenance activity performed at the second customer location 408 using the component. The status may be updated at additional, fewer, or alternative times.

Based upon the updated status of the component, the method may include determining the next destination and subsequently the route to the next destination 212. For instance, if the status of the component reveals that the component may not be re-used, the next destination determined may be a repair facility. On the other hand, if the status of the component reveals that the component may be re-used as is, the next destination determined may be a location associated with yet another customer or an associated nearby drop point. Accordingly, components in the field that remain in working order may be continuously redirected to additional customer cites or drop points without unnecessarily being routed back to a central location. Each working component may be redirected to different locations until either the component is used to actually replace a defective part of a machine or is itself damaged during maintenance.

The example of FIG. 4 demonstrates that a request for the component may be sent from the third customer location 410 or corresponding drop point to the IT system 402. Based upon the component status, the IT system 402 may determine that the component currently located at the second customer location 408 or corresponding drop point is in working condition and available for use. The IT system may then determine that the next destination for the component located at the second customer location 408 is the third customer location 410 or corresponding drop point.

Additionally, each route to the next destination may be an optimally calculated route, such as the most cost effective or time efficient route. The example of FIG. 4 shows that once the IT system 402 determines that a working component located at the second customer location 408 is requested by the third customer location 410, the IT system 402 calculates a route from the second customer location 408 to the third customer location 410 by which the component is to travel. Other routes may be calculated.

Using FIG. 3 to illustrate, after a component has been sent to a repair facility 310 and repaired, its status may be updated to reflect that the component is now in working condition. When the IT system receives a new request for the component from a customer location or corresponding drop point, the IT system may route the component from the repair facility 310 directly to that customer location or corresponding drop point. As a result, the component may not be needlessly shipped from the repair facility 310 to an intermediate destination, such as the central facility 304 or other storage facility.

As demonstrated by the embodiments and figures discussed above, the IT system may remotely monitor the status of components, as well as remotely track their location. The capability of remotely monitoring the status of components facilitates enhancing the routing of the components between various locations. Remotely monitoring the status also permits for quicker identification of DOA components, components damaged during use, and components that may not be re-used, such as due to their packaging being broken. The prompt identification of components that are no longer in working condition expedites the return of those components to a usable condition, as well as the shipment of working components to customers. Remote monitoring includes real-time monitoring or delayed feedback or updating of status of a component at a remote location.

Moreover, remote monitoring of components reduces the total number of components in the field as the number of components shipped from a central facility to each new customer may be lowered as some components requested for a new maintenance action may already be in circulation in the field. The components requested may be currently available to be shipped to the new customer from their current customer location. In some situations, the current customer location will be closer to the new customer location than the central facility. Remote monitoring of components at repair facilities also permits the direct routing of a component from a repair facility to a customer location.

### III. Additional Exemplary Embodiments

As note above, the workflow described herein may facilitate routing spare or replacement parts to pre-existing products/machines already in the field, such as at various customer locations. The spare parts may be used during the diagnostic testing of a product in the field experiencing operational difficulties.

In one embodiment, the pre-existing machines are medical devices and the customer locations are hospitals, clinics, or other medical facilities. As such, the workflow may be directed toward a number of medical devices, such as devices that display patient monitoring information, two or three dimensional medical images, electro-anatomical mapping or computed tomography/magnetic resonance images, and/or other information. The medical devices also may support electrophysiology, x-ray fluoroscopy, intra-cardiac (IC) echo, computed tomography, magnetic reasonance, ultrasound, or catheter ablation workflows. Additional, fewer, or alternative types of medical devices may be repaired in the field via diagnostic testing.

FIG. 5 is a block diagram of an exemplary data processor 510 configured or adapted to provide functionality for dynamically routing system components to various locations. The data processor 510 may include a central processing unit (CPU) 520, a memory 532, a storage device 536, a data input device 538, and a display 540. The data processor 510 also may have an external output device 542, which may be a display, a monitor, a printer and/or a communications port. The data processor 510 may be a personal computer, work station, server, medical device, or other system. The data processor 510 may be interconnected to a network 544, such as an intranet, the Internet, or an intranet connected to the Internet. The data processor 510 may be interconnected to another location via the network 544 either by data lines or by wireless communication. The data processor 510 may direct that the data received be stored on or read from machine-readable medium, including secondary storage devices such as hard disks, floppy disks, CD-ROMS, and DVDs; electromagnetic signals; or other forms of machine readable medium, either currently known or later developed. The data processor 510 is provided for descriptive purposes and is not intended to limit the scope of the present system. The data processor may have additional, fewer, or alternative components.

A program 534 may reside on the memory 532 and include one or more sequences of executable code or coded instructions that are executed by the CPU 520. The program 534 may be loaded into the memory 532 from the storage device 536. The CPU 520 may execute one or more sequences of instructions of the program 534 to process data. The program 534 may provide workflow assistance and functionality as discussed herein.

As shown in FIG. 5, the program 534 may permit a user to enter data into the data processor 510 via the data input device 538, the network 544, or another input device. After which, the data may be stored in the memory 532, the storage device 536, or other storage unit. Additionally, the data processed by the data processor 510 may be provided as an output to the display 540, the external output device 542, the network 544, and/or stored in a database.

In one embodiment, data may be received via the network 544 or other network. The data may originate from technicians in the field and/or from customer locations. The data may include the current status of a system component. The data processor 510 may receive and store the data received in the memory 532, the storage device 536, or other storage unit. The program 534 may direct that the data received be stored on or read from machine-readable medium, including secondary storage devices such as hard disks, floppy disks, CD-ROMS, and DVDs; electromagnetic signals; or other forms of machine readable medium, either currently known or later developed.

The data processor 510 may execute instructions that calculate an optimum shipping route between two locations given current conditions and shipping information. The optimum shipping route may be calculated to ship a system component in the most time efficient or cost effective, i.e., least expensive, manner. The data processor 510 also may be operable to remotely track the location of various system components as they are routed between different locations, as well as remotely maintain the current status of each component, whether the component is currently stored in a warehouse, at a repair facility, at a customer location, or at a different location.

The embodiments described herein may facilitate a faster process with respect to the ordering and the subsequent return system components than conventional processes. The new workflow may be more economical at least in part due to the automatic calculation of the most favorable route. The workflow may enable less inventory to be maintained in a central warehouse, which may substantially lower overhead costs, including the cost of the storage space and that of the inventory itself.

For instance, because available system components located anywhere, either at the central warehouse, any customer location, a repair facility, or anywhere else in the field, may be quickly identified and directly shipped to the next requesting customer, an excessive stock pile of system components at the central warehouse may be eliminated. In other words, the total inventory may be reduced because system components that are requested are made available to the customers faster.

Additionally, the workflow may reduce the amount of manual labor required to be performed at the central warehouse. DOA cases commonly occur in the vicinity of a customer location, such as where the system component was most recently used. Accordingly, the workflow may facilitate a closed loop control system that automatically identifies DOA components or other components in need of repair in a timely manner.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except as necessitated by the accompanying claims and their equivalents.

I claim:

1. A method of routing system components, the method comprising:
routing a component via a first route to a first location from a central warehouse;
determining whether the component remains in working condition after a servicing action at the first location;
determining with an Information Technology system a second route that will route the component directly to a second location from the first location based upon whether the component remains in working condition at the first location after the servicing action; and
routing the component via the second route to the second location.

2. The method of claim 1, wherein determining the second route comprises remotely calculating the most cost effective manner of shipping the component directly to the second location from the first location based upon current shipping information.

3. The method of claim 1, wherein determining the second route comprises remotely calculating the most time efficient manner of shipping the component directly to the second location from the first location based upon current shipping information.

4. The method of claim 1, wherein the first location is a location associated with a first customer, and the second location is a location associated with a second customer if the component is determined to be in working condition at the first location.

5. The method of claim 1, wherein the first location is a location associated with a first customer, and the second location is a location associated with a repair facility if the component is determined not to be in working condition at the first location, the repair facility being capable of repairing the component if it is not in working condition.

6. The method of claim 1, the method comprising automatically assigning the component a status after the servicing action, the status is reported to a remotely located control unit and may comprise whether the component is in working condition.

7. The method of claim 6, wherein the status of the component may be remotely retrieved via a communications network.

8. A method of routing system components, the method comprising:
remotely maintaining the status of a component located at a first location, the status of the component includes whether the component remains in working condition at the first location, the first location being associated with a first customer; and
remotely routing via an Information Technology system the component directly to a second location, the determination of the second location is based upon whether or not the component remains in working condition at the first location.

9. The method of claim 8, the method comprising remotely tracking the location of the component in the field via the Information Technology system.

10. The method of claim 8, wherein the second location is associated with a second customer if the component remains in working condition at the first location.

11. The method of claim 8, wherein the second location is associated with a repair facility at which the component may be repaired if the component no longer remains in working condition at the first location.

12. The method of claim 8, comprising determining a first optimum route by which to route the component directly from the first location to the second location.

13. The method of claim 8, comprising:
determining a second optimum route by which to route the component to the first location from a central warehouse, the first location being a location of a product which requires the component to complete diagnostic testing of the product; and
routing the component to the first location via the second optimum route.

14. The method of claim 8, wherein the status identifies that the component arrived at the first location in a defective state.

15. The method of claim 8, wherein the status identifies that the component may not be re-used after being used to troubleshoot a machine located at the first location.

16. A processing system operable to route components, the system comprising:
a processor operable to remotely maintain the current status of a component located at a first location associated with a first customer, wherein the processor is operable to determine a route by which the component may be transported from the first location directly to a second location based upon the current status of the component at the first location.

17. The system of claim 16, wherein the processor is operable to remotely track the current location of the component.

18. The system of claim 16, wherein the current status of the component is assigned via a mobile servicing tool and subsequently remotely transmitted to the processor.

19. The system of claim 16, wherein the current status of the component identifies that the component may not be re-used after being used in connection with a servicing action associated with a product located at the first location.

20. The system of claim 16, wherein the processor is operable to route the component to a second customer from the first location if the component may be re-used or to a repair facility from the first location if the component may not be re-used.

21. A computer-readable medium having instructions executable on a computer stored thereon, the instructions comprising:
receiving information detailing the current status of a component, the component being located at a first remote location; and
determining an optimum route from the first remote location to a second remote location based upon the current status of the component at the first remote location.

22. The computer-readable medium of claim 21, the instructions comprising determining whether the component may be re-used based upon the current status.

23. The computer-readable medium of claim 22, wherein the second remote location is associated with a customer if the component may be re-used and with a repair facility if the component may not be re-used.

24. The computer-readable medium of claim 23, the instructions comprising assigning the current status of the component after a servicing action associated with a product located at the first remote location, the component being used during the servicing action.
